(19) United States
(12) Patent Application Publication
(10) Pub. No.: US 2026/0094369 A1
(43) Pub. Date: Apr. 2, 2026

(54) SYSTEMS AND METHODS FOR FEATURE DETERMINATION FOR CONCAVE MESH COLLISION

(71) Applicant: Electronic Arts Inc., Redwood City, CA (US)

(72) Inventor: Lee CULLEN, Waterlooville (GB)

(73) Assignee: Electronic Arts Inc., Redwood City, CA (US)

(21) Appl. No.: 18/901,241

(22) Filed: Sep. 30, 2024

(51) Int. Cl. G06T 17/20

(52) U.S. Cl. CPC G06T 17/20; G06T 2210/21

(57) ABSTRACT

Unresolved primitives of mesh objects are determined. A primary feature of a primitive of the mesh object is determined to be a vertex or edge. The primary feature is marked as a first unresolved primitive. All unresolved primitives or the mesh object colliding with a convex hull object are collected into a sorted list. The first unresolved primitive is determined to be a first link in a chain of unresolved primitives. An edge of the first unresolved primitive is determined to be marked as being walked through to continue to build the chain of unresolved primitives based on the primary feature and features connected to the primary feature. An index of the first unresolved primitive and an index of the edge marked as being walked through are added to the chain. A determination is made to continue to build the chain based on the extracted features of the neighboring primitive.

### FIELD

This disclosure generally relates to computer graphics and, more particularly, to system and methods for contact generation between graphical objects in flat and concave regions of a mesh, and interactions between a convex hull with a mesh object as a whole.

### BACKGROUND

In computer-generated graphics applications, such as video games or animated films, characters in the graphics application typically comprise 3D (three-dimensional) character models. In the context of video games, an in-game character model may include hundreds of adjustable parameters. The parameters can be modified to give the in-game character a distinct appearance. The in-game character model may interact with the environment in different ways such as by jumping off ledges, bouncing off walls, or crashing through other objects.

Computer-generated graphics applications often determine contact points or execute contact generation between two objects to prevent clipping between the objects as they intersect or otherwise interact with each other. Performing contact generation improperly introduces visual artifacts that destroy the immersion of the player as an avatar or in-game character model interacts with their surrounding environment.

As used herein, “clipping” refers to two or more objects intersecting improperly. An example of clipping is when a first object goes through another object in an unrealistic way, such as by clipping a foot of an in-game character through a floor of an environment where in the real world someone's foot would stand in contact with the floor and not penetrate the floor. Various problems can occur when attempting to execute contact generation for objects and, in particular, when treating a mesh object with concave or flat edges as a collection of individual primitives constructed from the polygonal faces of the mesh during contact generation. For example, when a convex hull approaches an edge of a mesh, unlike in a convex case, regions connected by flat or concave joins can have different times of impact (TOI) for each region. In scenarios where an object may collide with a mesh that represents a floor meeting a wall, depending on the speed of the object, the object may intersect with both the floor and the wall requiring contact points to be generated for the floor and the wall. It should be noted that after a first impact the motion of the two objects may not follow a predicted trajectory. Contact points may need to be generated to prevent secondary collisions. However, this is difficult as TOI is generated, as well as a point of closest approach and best separating direction, without knowledge of the initial impact.

One issue with contact generation arises when a system treats each primitive of a mesh object separately for determining collision with another object, for example, a hull object such as a convex hull resting on a flat mesh. A primitive, as used herein, refers to a polygonal cell comprised of vertices, edges, and a face, which is the building block of a mesh. In this scenario, contact points are generated for each corner of the bottom face of the convex hull, each edge of the mesh where the convex hull crosses the mesh, and at mesh vertices that are within the bounds of a bottom face of the convex hull. This produces many redundant contacts that do not help prevent clipping and also cost computing time to generate and solve. Another scenario, such as in sliding cases, the system can determine a bad best separating direction (BSD) which is back along the direction of travel for the convex hull and therefore generate bad contacts that block valid motion for the convex hull. In yet another scenario, such as in falling cases for the convex hull, the time of impact and BSD with one primitive of the convex hull can be back facing, since the convex hull can travel through the face of the neighboring primitive which is considered separately for contact generation. A back facing BSD results in no contacts being generated which can lead to incorrect penetrations by the convex hull of a mesh object. Properly determining contact points between objects only gets more complicated when considering an object being rotated during collision, feature clipping due to non-flat surfaces, or sliding cases where an object may slide along a non-flat surface.

### SUMMARY

Embodiments of the disclosure provide a method, computer-readable storage medium, and device for feature determination for a convex hull colliding with a mesh. The method includes: determining a primary feature of a primitive of a mesh object is either a flat or concave edge, or a vertex connected to the flat or concave edge and marking it as unresolved; collecting all unresolved primitives for the mesh object colliding with a convex hull object into a sorted list; determining that the first unresolved primitive is a first link in a chain of unresolved primitives; determining an edge of the first unresolved primitive to mark as being walked through to continue to build the chain of unresolved primitives based on the primary feature and features connected to the primary feature; adding to the chain an index of the first unresolved primitive and an index of the edge of the first unresolved primitive marked as being walked through; extracting features of a neighboring primitive to the first unresolved primitive by walking across the marked edge; determining to continue to build the chain based on the extracted features of the neighboring primitive; and determining to end the chain based on the neighboring primitive being resolved, based on the extracted features.

### BRIEF DESCRIPTION OF THE DRAWINGS

FIG. 1 is a block diagram of a computer system for rendering images, according to aspects of the present disclosure.

FIG. 2 is a block diagram illustrating processor and buffer interaction, according to an embodiment.

FIG. 3 is a conceptual diagram illustrating a hull object colliding with a mesh object and determining contact points between the hull object and the mesh object, according to an embodiment.

FIG. 4 is a conceptual diagram illustrating a hull object colliding with a mesh object and determining contact points between the hull object and the mesh object, according to an embodiment.

FIG. 5 is a conceptual diagram illustrating a hull object colliding with a mesh object and determining contact points between the hull object and the mesh object, according to an embodiment.

FIG. 6 is a conceptual diagram illustrating a hull object colliding with a mesh object with concave edges and determining contact points between the hull object and the mesh object, according to an embodiment.

FIG. 7 is a conceptual diagram illustrating a hull object colliding with a mesh object and determining contact points between the hull object and the mesh object, where the mesh feature is an edge, according to an embodiment.

FIG. 8 is a conceptual diagram illustrating generating edge clips during feature intersection for edge and face features of a convex hull against a face feature of a mesh by projecting the features onto a common plane defined by the contact normal, according to an embodiment.

FIG. 9 illustrates conceptual diagrams of generating an edge clip in a scenario where a mesh vertex connected to an edge also intersects with a convex hull face, according to some embodiments.

FIG. 10 is a flow diagram of method steps for determining contact points for a convex hull colliding with a mesh, according to an embodiment.

FIG. 11 is a conceptual diagram illustrating a hull object potentially colliding with a mesh object and determining to reject a target primitive when a corresponding source primitive is rejected, according to an embodiment.

FIG. 12 is a conceptual diagram illustrating a hull object colliding with a mesh object and resolving a target feature where the source primitive primary feature is a face, according to an embodiment.

FIG. 13 is a conceptual diagram illustrating a hull object colliding with a mesh object and resolving a target feature where the source primitive primary feature is a face, according to an embodiment.

FIG. 14 is a conceptual diagram illustrating a hull object colliding with a mesh object and resolving a feature where a primary feature of a source primitive is a convex edge, according to an embodiment.

FIG. 15 is a conceptual diagram illustrating a hull object colliding with a mesh object and resolving a feature where a primary feature of a source primitive is a convex edge and extra primitives are present between the source primitive and the target primitive, according to an embodiment.

FIG. 16 is a conceptual diagram illustrating decomposition of the source primary feature normal into two vectors, according to an embodiment.

FIG. 17 is a conceptual diagram depicting the generation of incorrect contacts between a hull and mesh object, according to an embodiment.

FIG. 18 is a conceptual diagram illustrating generation of a source plane when a primary feature of a source primitive is a convex edge, according to an embodiment.

FIG. 19 is a conceptual diagram depicting an example of an unresolved feature chain, according to an embodiment.

FIG. 20 is a conceptual diagram depicting generating of a chain of primitives to resolve remaining unresolved primitive pairs for mesh objects, according to an embodiment.

FIG. 21 is a flow diagram of method steps for feature determination for a convex hull colliding with a mesh object, according to an embodiment.

### DETAILED DESCRIPTION

The following detailed description provides examples that are not intended to limit the disclosure or the application and uses of the disclosure. Furthermore, there is no intention to be bound by any expressed or implied theory presented in the preceding technical field, background, summary, brief description of the drawings, or the following detailed description.

As described in greater detail herein, embodiments of the disclosure provide a system and method for feature determination for colliding a hull, such as a convex hull, with a mesh using chains of unresolved primitives of the mesh.

As described in greater detail herein, embodiments of the disclosure provide a system and method for determining contact points for colliding a convex hull object with a mesh using generated edge clips. In some embodiments, input is provided to a feature intersection algorithm that a joining edge of a mesh is flat or concave and instead of creating a contact point at the edge, the system generates an “edge clip.” The edge clip may store where the features of a hull object and mesh object intersect or clip against each other, and an identifier (ID) of the edge in the mesh object where it has clipped against the hull object. In some embodiments, the edge clips may be stored in such a manner that to identify from which mesh face they originated. The feature intersection algorithm may include an algorithm or system to compute intersections or closest points between features (such a vertex, edge or face) of two objects by projecting the features of each object onto a common plane defined by the contact normal.

The present disclosure provides a system that solves contact generation issues of meshes in flat and concave regions by considering how the surrounding primitives of the meshes are connected. In some embodiments, the system may consider surrounding primitives by face walking to extend contact points across mesh face boundaries. In an embodiment, the system may create edge clips rather than contact points at flat edges, with the edge clips storing the clipping points and edge IDs. The edge clips and face walking are then used to find neighboring mesh primitives that are used to generate contact points with the same hull object. This implementation can be also applied to concave edges by using an infinite plane of a source mesh primitive to generate contact points with a neighboring primitive of a mesh object. The contact points are then projected onto the same plane as the feature used by the source mesh primitive, which prevents a hull object from penetrating the source mesh primitive.

In some embodiments, a system, such as a computer system, may solve contact issues of meshes in flat and concave regions by considering how the surrounding primitives of the meshes are connected. To properly resolve interactions between meshes, the present disclosure considers the interaction of a convex hull object with a mesh object as a whole, rather than as a collection of separate primitives. Conventional solutions only consider each primitive of the mesh in isolation. However, these conventional approaches can lead to generating incorrect contact points between the hull object and the mesh object.

In some embodiments, two new feature types are introduced in the present disclosure in addition to vertex, edge, face and rejected features: (a) a deferred feature type, and (b) a pass-through feature type. A deferred feature type may be used when the system is unable to determine, by looking at a single primitive, what the correct feature for contact generation should be for the mesh object. The deferred feature type may be used to defer feature determination until a second pass over the mesh object is performed, where the system analyzes surrounding primitives of the deferred feature type primitive. A pass-through feature type is used for features where the system does not generate contact points directly with a given primitive, but will still allow other primitives to use a pass-through feature to generate contacts. These feature types along with other feature types may be used to build a chain of primitives where one end of the chain has a resolved primitive (a known feature such as a vertex, edge, face or rejected will be used for contact generation for the primitive); this is referred to as a source primitive; and each subsequent link in the chain is a primitive with an unresolved or semi-resolved feature. A chain may end on a target primitive that is capable of being resolved, thereby generating a single path from a target primitive to a source primitive. Once a chain is built, the chain can be walked over to resolve primitives, which in turn can be used to address contact issues, such as when generating contact points when colliding a hull object with the mesh object.

Taking the context of video games as an example, the display of a video game is generally a video sequence presented to a display capable of displaying the video sequence. The video sequence typically comprises a plurality of frames. By showing frames in succession in sequence order, simulated objects appear to move. A game engine typically generates frames in real-time response to user input, so rendering time is often constrained.

As used herein, a “frame” refers to an image of the video sequence. In some systems, such as interleaved displays, the frame might comprise multiple fields or more complex constructs, but generally a frame can be thought of as a view into a computer-generated scene at a particular time or short time window. For example, with 60 frames-per-second video, if one frame represents the scene at t=0 seconds, then the next frame would represent the scene at t= 1/60 seconds or 16 ms. In some cases, a frame might represent the scene from t=0 seconds to t= 1/60 seconds, but in the simple case, the frame is a snapshot in time.

A “scene” comprises those simulated objects that are positioned in a world coordinate space within a view pyramid, view rectangular prism or other shaped view space. In some approaches, the scene comprises all objects (that are not obscured by other objects) within a view pyramid defined by a view point and a view rectangle with boundaries being the perspective planes through the view point and each edge of the view rectangle, possibly truncated by a background.

The simulated objects can be generated entirely from mathematical models describing the shape of the objects (such as arms and a torso described by a set of plane and/or curve surfaces), generated from stored images (such as the face of a famous person), or a combination thereof. If a game engine (or more specifically, a rendering engine that is part of the game engine or used by the game engine) has data as to where each object or portion of an object is in a scene, the frame for that scene can be rendered using standard rendering techniques.

A scene may comprise several objects or entities with some of the objects or entities being animated, in that the objects or entities may appear to move either in response to game engine rules or user input. For example, in a basketball game, a character for one of the basketball players might shoot a basket in response to user input, while a defending player will attempt to block the shooter in response to logic that is part of the game rules (e.g., an artificial intelligence component of the game rules might include a rule that defenders block shots when a shot attempt is detected) and when the ball moves through the net, the net will move in response to the ball. The net is expected to be inanimate, but the players' movements are expected to be animated and natural-appearing. Animated objects are typically referred to herein generically as characters and, in specific examples, such as animation of a football, soccer, baseball, basketball, or other sports game, the characters are typically simulated players in the game. In many cases, the characters correspond to actual sports figures and those actual sports figures might have contributed motion capture data for use in animating their corresponding character. Players and characters might be nonhuman, simulated robots, or other character types.

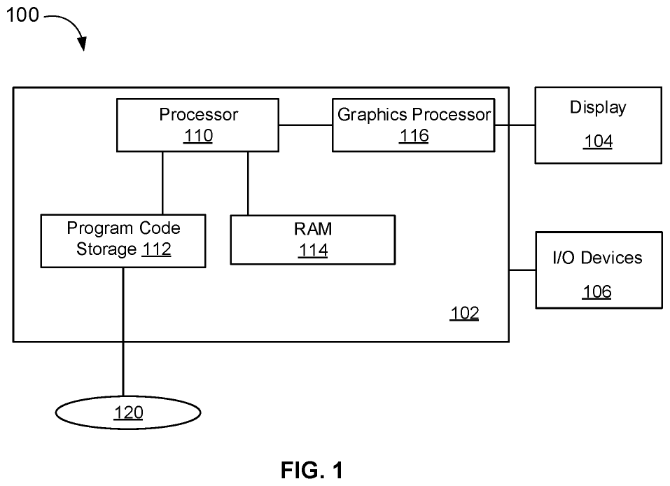

Turning to the drawings, FIG. 1 is a block diagram of a computer system 100 for rendering images, according to aspects of the present disclosure. The computer system 100 may be, for example, used for rendering images of a video game. The computer system 100 is shown comprising a console 102 coupled to a display 104 and input/output (I/O) devices 106. Console 102 is shown comprising a processor 110, program code storage 112, temporary data storage 114, and a graphics processor 116. Console 102 may be a handheld video game device, a video game console (e.g., special purpose computing device) for operating video games, a general-purpose laptop or desktop computer, or other suitable computing system, such as a mobile phone or tablet computer. Although shown as one processor in FIG. 1, processor 110 may include one or more processors having one or more processing cores. Similarly, although shown as one processor in FIG. 1, graphics processor 116 may include one or more processors having one or more processing cores.

Program code storage 112 may be ROM (read only-memory), RAM (random access memory), DRAM (dynamic random access memory), SRAM (static random access memory), hard disk, other magnetic storage, optical storage, other storage or a combination or variation of these storage device types. In some embodiments, a portion of the program code is stored in ROM that is programmable (e.g., ROM, PROM (programmable read-only memory), EPROM (erasable programmable read-only memory), EEPROM (electrically erasable programmable read-only memory), etc.) and a portion of the program code is stored on removable media such as a disc 120 (e.g., CD-ROM, DVD-ROM, etc.), or may be stored on a cartridge, memory chip, or the like, or obtained over a network or other electronic channel as needed. In some implementations, program code can be found embodied in a non-transitory computer-readable storage medium.

Temporary data storage 114 is usable to store variables and other game and processor data. In some embodiments, temporary data storage 114 is RAM and stores data that is generated during play of a video game, and portions thereof may also be reserved for frame buffers, depth buffers, polygon lists, texture storage, and/or other data needed or usable for rendering images as part of a video game presentation.

In one embodiment, I/O devices 106 are devices a user interacts with to play a video game or otherwise interact with console 102. I/O devices 106 may include any device for interacting with console 102, including but not limited to a video game controller, joystick, keyboard, mouse, keypad, VR (virtual reality) headset or device, etc.

Display 104 can any type of display device, including a television, computer monitor, laptop screen, mobile device screen, tablet screen, etc. In some embodiments, I/O devices 106 and display 104 comprise a common device, e.g., a touchscreen device. Still further, in some embodiments, one or more of the I/O devices 106 and display 104 is integrated in the console 102.

In various embodiments, since a video game is likely to be such that the particular image sequence presented on the display 104 depends on results of game instruction processing, and those game instructions likely depend, in turn, on user inputs, the console 102 (and the processor 110 and graphics processor 116) are configured to quickly process inputs and render a responsive image sequence in real-time or near real-time.

Various other components may be included in console 102, but are omitted for clarity. An example includes a networking device configured to connect the console 102 to a network, such as the Internet.

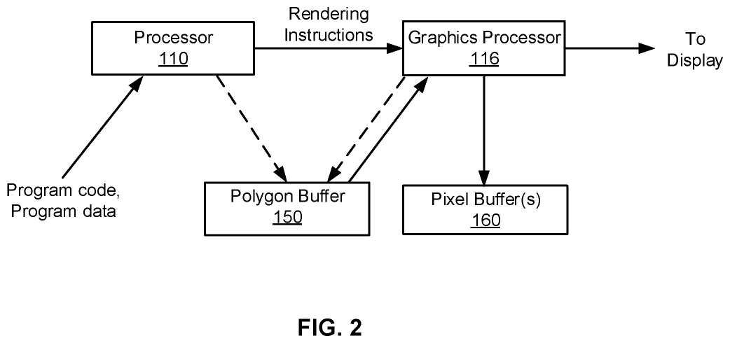

FIG. 2 is a block diagram illustrating processor and buffer interaction, according to one embodiment. As shown in FIG. 2, processor 110 executes program code and program data. In response to executing the program code, processor 110 outputs rendering instructions to graphics processor 116. Graphics processor 116, in turn, reads data from a polygon buffer 150 and interacts with pixel buffer(s) 160 to form an image sequence of one or more images that are output to a display. Alternatively, instead of sending rendering instructions to graphics processor 116 or in addition to sending rendering instructions to graphics processor 116, processor 110 may directly interact with polygon buffer 150. For example, processor 110 could determine which objects are to appear in a view and provide polygon or other mathematical representations of those objects to polygon buffer 150 for subsequent processing by graphics processor 116.

In one example implementation, processor 110 issues high-level graphics commands to graphics processor 116. In some implementations, such high-level graphics commands might be those specified by the OpenGL specification, or those specified by a graphics processor manufacturer.

In one implementation of an image rendering process, graphics processor 116 reads polygon data from polygon buffer 150 for a polygon, processes that polygon and updates pixel buffer(s) 160 accordingly, then moves on to the next polygon until all the polygons are processed, or at least all of the polygons needing to be processed and/or in view are processed. As such, a renderer processes a stream of polygons, even though the polygons may be read in place and be a finite set, where the number of polygons is known or determinable. For memory efficiency and speed, it may be preferable in some implementations that polygons be processed as a stream (as opposed to random access, or other ordering), so that fast, expensive memory used for polygons being processed is not required for all polygons comprising an image.

In some embodiments, processor 110 may load polygon buffer 150 with polygon data in a sort order (if one is possible, which might not be the case where there are overlapping polygons), but more typically polygons are stored in polygon buffer 150 in an unsorted order. It should be understood that although these examples use polygons as the image elements being processed, the apparatus and methods described herein can also be used on image elements other than polygons.

In computer-generated visual content (such as interactive video games), objects may be represented by various computer-generated models, including polygonal meshes and texture maps. A polygonal mesh herein shall refer to a collection of vertices, edges, and faces that define the shape and/or boundaries of a three-dimensional object. A texture map herein shall refer to a projection of an image onto a corresponding polygonal mesh.

Texture mapping provides a method to map colors and other information to pixels from one or more 2D textures to a 3D surface of an object, analogous to “wrapping” a 2D image around the 3D object. In the advent of multi-pass rendering, texture mapping can also include more complex mappings, such as height mapping, bump mapping, normal mapping, displacement mapping, reflection mapping, specular mapping, occlusion mapping, and the like. These techniques make it possible to create near-photorealistic renderings of 3D objects.

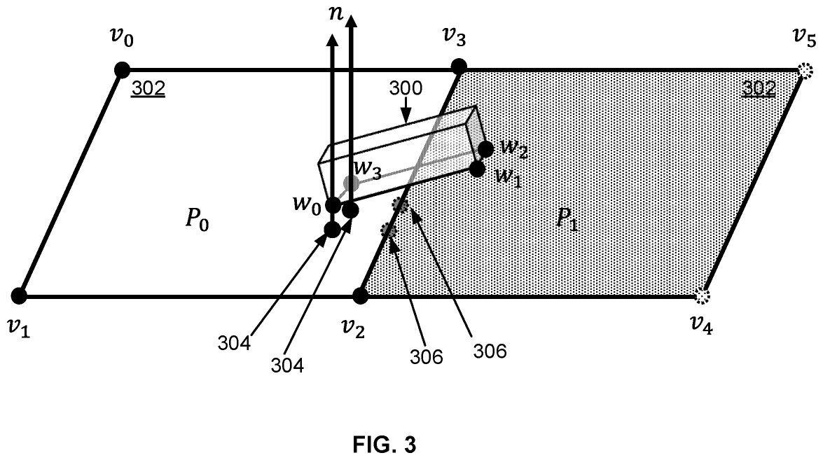

FIGS. 3-5 depict conceptual diagrams illustrating a hull object colliding with a mesh object and determining contact points between the hull object and the mesh object, according to an embodiment. As described herein, problems exist with feature clipping, where objects may end up clipping face features of the convex hull against flat or concave edges of a mesh object, resulting in a set of contacts between these two objects that can still allow for penetration or incorrect collision. Conventional solutions may attempt to resolve this by generating an excessive number of contact points between internal edges of flat faces of the mesh object. This is a consequence of treating each primitive separately rather than a deliberate attempt to make more contacts. Some solutions treat each primitive in a mesh object separately, so contacts are generated at every point where an edge of a convex hull intersects with an edge of a mesh object, or where a vertex of a mesh object is fully inside a face of a hull object.

In one example, a convex hull sits on a flat mesh object, where the convex hull straddles two mesh faces. If the two resulting mesh faces are treated separately, one could find the best separating direction and TOI for each face. To generate contacts, a system can run two passes of a feature intersection algorithm with each mesh face. By doing this, each mesh face generates its own contact points with the hull object. Systems that use a contact solver may implement infinite planes to solve the generated contact constraints in this scenario. Since the mesh is flat, the normal of all the contacts for both mesh faces are the same, and the contact solver may see several contacts all against the same infinite plane. However, in cases where the convex hull is flat or close to flat on the mesh, typically the best separating direction (BST) with each mesh primitive will be the normal of the mesh faces. This results in excessive contact point generation. In cases where the convex hull represents a box that is rotated and colliding with the mesh, the best separating direction with one of the primitives of the mesh will be normal to the flat edge, but not normal to the face. This results in the mesh primitive being rejected for contact generation thereby not generating all the contacts required to prevent penetration by the box of the mesh. Rejection occurs to prevent edge contacts that will snag the horizontal movement of the box.

In accordance with at least one embodiment, the systems and methods of the present disclosure can provide input to the feature intersection algorithm that a joining edge is flat, and instead of creating a contact point at the edge, the present disclosure generates an edge clip. The edge clip stores where the features clip against each other as well as the ID of the edge in the mesh the object clipped against. The system may loop over the edges the object clipped against to find the neighboring mesh primitives (e.g., faces). The system may then run the feature intersection algorithm again using the same feature from the convex hull but using the feature of the neighboring mesh primitive. The neighboring primitive may be processed again and instead of creating contact points on the flat edge, an edge clip may be created. This prevents the system from generating contacts along an internal edge between two faces of a mesh object and ensures that the contact points are placed at appropriate points on the convex hull object to prevent penetration thereby resolving the problems discussed above (e.g. excessive contact point generation and inappropriate contact point placement that still allows penetration).

FIGS. 3-5 depict an example of generating contact points for a collision between hull object 300 and mesh object 302 with primitives P₀ and P₁. The features of the present disclosure may generate contact points 304 between hull object 300 and mesh object 302 using a face feature of primitive P₀. The system may consider the face feature of primitive P₀ as the set of vertices {v₀, v₁, v₂, v₃} and hull face as the set of vertices {w₀, w₁, w₂, w₃}. The system may generate the contact points 304 and an edge clip for the edge {v₂, v₃} and store the contact points that were clipped and generated (depicted at 306). In some embodiments, the system may process the edge {v₂, v₃} of the edge clip and find that primitive P₁ is the mesh primitive on the opposite side of the edge {v₂, v₃}. Primitive P₀ can also then be marked are processed, so that in further iterations of the process for other primitives the primitive P₀ can be skipped as already processed.

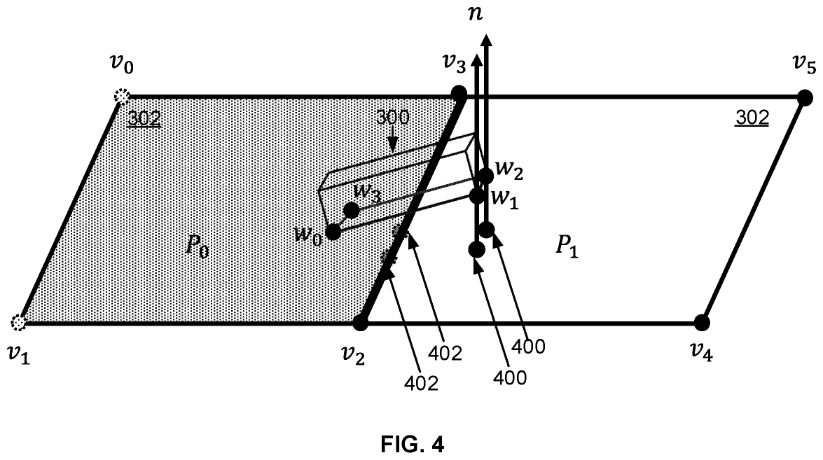

FIG. 4 depicts the generation of contact points between the hull object 300 and primitive P₁ using the mesh face {v₄, v₅, v₃, v₂} and hull face {w₀, w₁, w₂, w₃}. The system creates two contact points 400 and then generates an edge clip consisting of the edge {v₃, v₂} and stores the points that were clipped (depicted at 402). The system then processes the edge clip from primitive P₁ and determines that primitive P₀ has already been processed and no further action is necessary.

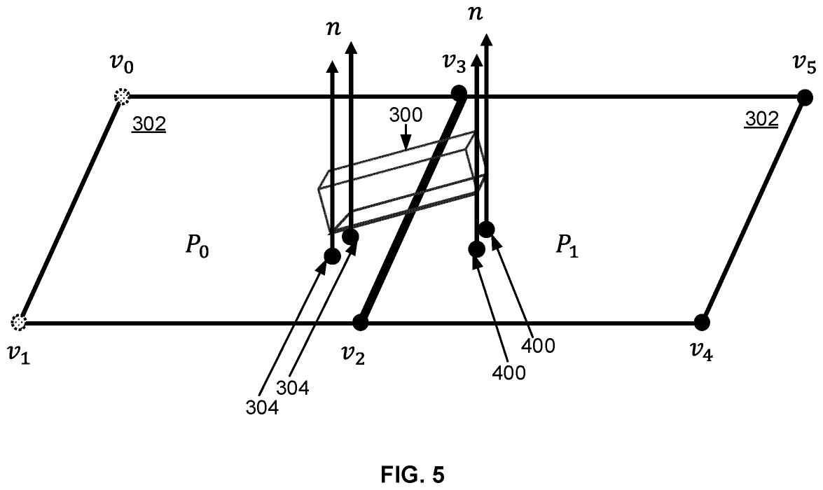

FIG. 5 depicts the final result where the two contacts 304 and the two contacts 400 are generated for hull object 300. For flat face mesh objects, such as 302 of FIGS. 3-5, the system provides improvements over conventional systems by no longer needing to generate contact points on internal edges/vertices, guaranteeing to generate all the contact points required to prevent the hull object 300 from penetrating the contact plane, and is faster as the system does not need to reload convex hull data. The process described above with reference to FIGS. 3-5 of creating edge clips and then processing neighboring faces is referred to herein as “face walking.”

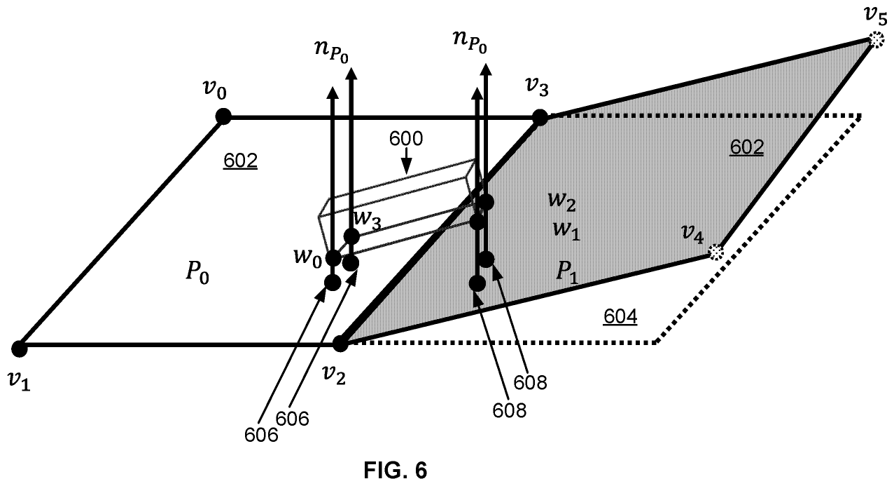

FIG. 6 is a conceptual diagram illustrating a hull object 600 colliding with a mesh object 602 with concave edges and determining contact points between the hull object 600 and the mesh object 602, according to an embodiment. FIG. 6 depicts the application of face walking to concave edges. In order to resolve collisions, contact constraints may include a point on each object and an infinite plane that separates the two points on each object. At a concave join between two faces, the infinite plane of both faces connects through the shared edge to extend underneath the opposite face. This is depicted in FIG. 6 as infinite plane of P₀ extends under P₁. This can be used by the system to ensure that it is safe to generate contact points with the extended plane 604 as it will never prevent any valid motion of the hull object 600.

In particular, FIG. 6 depicts the contact points 606 generated using the face feature of primitive P₀ of the mesh object 602 against the bottom face of the hull object 600. An edge clip is generated for edge {v₂, v₃}. In some embodiments, the system may face walk edge {v₂, v₃} and then move into the primitive on the opposite side of the edge, i.e., primitive P₁. The face feature and vertices of primitive P₁ along with the normal of primitive P₀ (nₚ₀) are used to generate contact points on the surface of primitive P₁. These contact points on the surface of primitive P₁ are then projected on to the same plane as the original feature, i.e., the face of P₀, along the contact normal nₚ₀ to generate contact points 608 on the plane of the face of P₀. By generating the contact points 606 and 608 in this manner, the hull object 600 is prevented from penetrating P₀, even if the hull object 600 moves further towards P₀ or rotates.

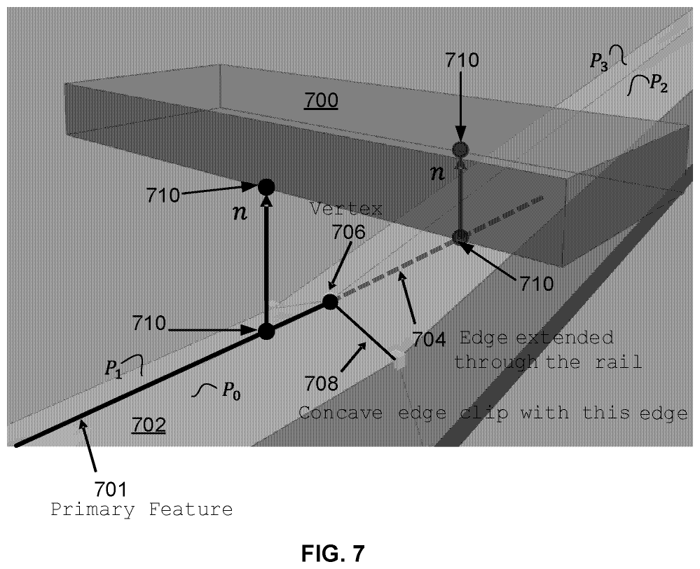

FIG. 7 is a conceptual diagram illustrating a hull object 700 colliding with a mesh object 702 and determining contact points between the hull object 700 and the mesh object 702, where the mesh feature is an edge, according to an embodiment. Mesh object 702 includes primitives P₀, P₁, P₂, and P₃. Certain scenarios may occur where a mesh feature of collision of the hull object 700 and the mesh object 702 could be an edge of the mesh object 702 that is connected to one or more flat or concave edges. The example depicted in FIG. 7 includes a convex hull object 700 is above a rail (mesh object 702), where the top edge of the rail joins at a concave angle. The mesh feature for the collision for primitive P₀ is the same mesh feature for the collision for primitive P₁ (i.e., the edge between primitive P₀ and primitive P₁). Primitives P₀ and P₁ may comprise the convex edge 701 on the top of the rail (mesh object 702). FIG. 7 also depicts the extension 704 of the convex edge 701 depicted as the primary feature in FIG. 7. The system may use the convex edge 701 of the mesh against the bottom face of the convex hull 700 to generate contacts.

A conventional system may create a contact point at the vertex 706 at the end of the edge between the faces of primitive P₀ and primitive P₁. This would produce a contact point roughly in the center of the bottom face of the convex hull 700. However, if the hull object 700 were to slide towards the edge 701 (primary feature) during a time step, it would be possible for the bottom face of the hull object 700 to penetrate the top edge of the mesh 702. Instead, the system of the present disclosure uses face walking to generate contact points that prevent penetration with the edge 701 or primary feature. During this face walking, since the other edge of the vertex 706 is concave, the vertex 706 may be flagged and then passed on to the feature intersection algorithm. Instead of creating a contact, some embodiments can add an edge clip using the non-convex edge 708 as depicted in FIG. 7 (e.g., edge 708). The system may then identify a primitive on the opposite side of the edge 708 and use the feature associated with that mesh primitive (P₂) in order to create contact points 710 on the extended edge 704.

Some embodiments of the present disclosure may further utilize contact filtering. As the system face walks, a primary and a promoted feature of a mesh primitive the system has stepped into may not be the same. A primary feature, as used herein, includes the feature (vertex, edge, or face) that is most perpendicular of the best separating direction. In the case of a tie, some embodiments choose the higher order feature. For example, the order of preference for the system may be first face, then edge, then vertex. A promoted feature, as used herein, includes a higher order feature that is considered close enough to perpendicular to the best separating direction (BSD) (for example, within a threshold) such that it would be beneficial to use it to generate contacts. In the case of a tie, the system may choose the higher order feature. For example, in FIG. 7 the angle of the faces that formed the rail object of the mesh object 702 could be such that the faces on either side of the convex edge are approaching co-linear. In such scenarios it is likely that the primary feature is the convex edge and the promoted feature is the face. This would happen to prevent small rotations of the hull 700 penetrating the faces of the rail 700. This can be resolved when generating contacts with P₀ by adjusting the contact normal for contacts generated on the edge to use the primary normal (edge normal) rather than the promoted (face) normal. The system does this when face walking thereby ensuring that contacts generated on the extended edge 704 will use the primary feature normal.

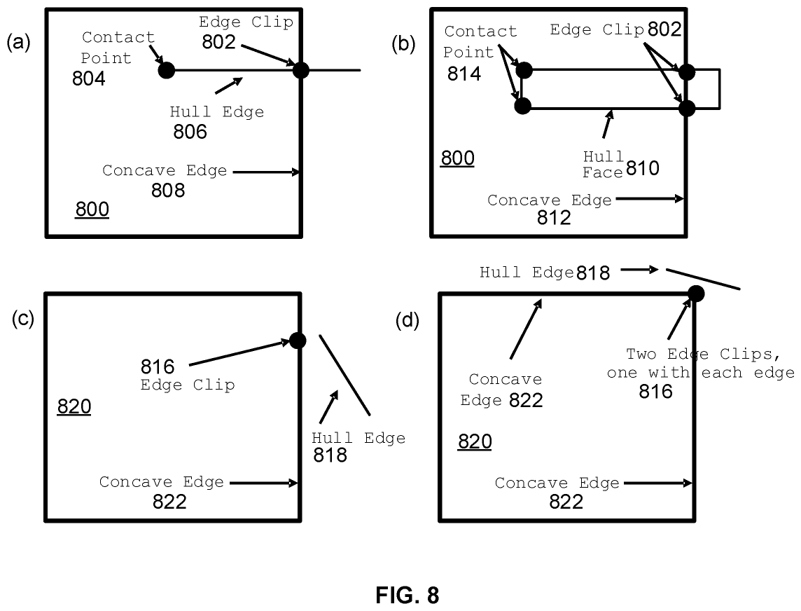

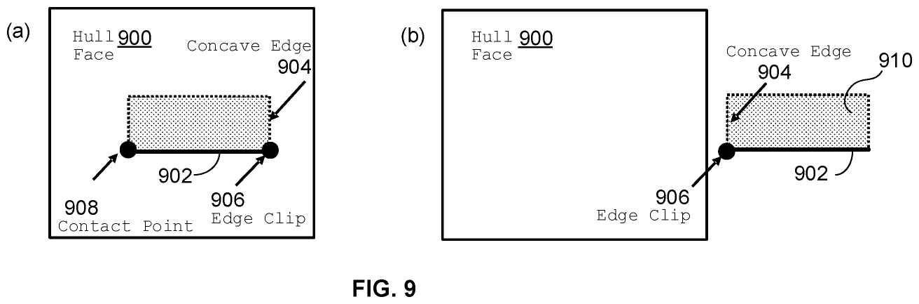

FIG. 8 is a conceptual diagram illustrating generating edge clips during feature intersection for edge and face features of a convex hull against a face feature of a mesh by projecting the features onto a common plane defined by the contact normal, according to an embodiment. In some embodiments, face walking may include, when obtaining mesh primitive vertices, the promoted feature of the mesh being a face and obtaining the list of concave and flat edges in the face, or the promoted feature being an edge and determining if the two adjacent edges (one connected to each vertex) are concave or flat. The system may also, when executing the feature intersection algorithm (depicted in FIGS. 8 and 9), create an edge clip instead of a contact point in scenarios where a mesh face intersects with a hull face or edge and if an edge of the hull intersects a flat or concave edge of the mesh. When executing the feature intersection algorithm, the system may also create an edge clip instead of creating contact points in scenarios where the convex hull feature is within a region, such as a Voronoi region, of a concave edge and outside the bounds of the mesh face. A Voronoi region may include a region in which a number of points scattered on a plane divides the plane into regions of exactly n cells such that the points of each cell are closest to a seed point. When executing the feature intersection algorithm the system may also create an edge clip instead of creating a contact point in scenarios where the mesh edge intersects with a hull face if a vertex on the edge is inside the hull face and the edge vertex has a flat or concave adjacent edge. When executing the feature intersection algorithm, the system may also create an edge clip instead of creating a contact point in scenarios where the mesh edge is fully outside a hull face and a mesh vertex adjacent to a flat or concave edge is the nearest feature.

The face walking algorithm may include, for each edge clip, determining whether to face walk into a neighboring primitive of a mesh object. A positive determination to face walk into a neighboring primitive results in the neighboring primitive being added to a list of primitives to visit. The face walking algorithm may use several conditions for determining to face walk into a neighboring primitive such as: if there is a mesh primitive on the other side of the edge (i.e. the edge is not open); there is a valid primitive pair that is considered colliding with the hull associated with the neighboring mesh primitive; if primitives with rejected features are accepted since the system only extends the contact points for a current normal, in such scenarios the algorithm may use the face as the feature or determine it some other way; if the primitive hasn't already been visited from the start primitive and the system hasn't already added the primitive to the list (this prevents circular walks); in scenarios where the face walking has to walk flat edges—check that the system hasn't processed the potential primitive for contact generation already (this prevents creating duplicate contacts for flat faces); and if the primitive being walked into forms an angle smaller than 90° with the original primitive as once the system goes past this limit the best separating direction is not useful and no partial overlap of the extended plane is allowed. The face walking algorithm also includes, for each item in the list of primitives to visit, extracting the mesh feature and performing contact generation with the hull feature.

FIG. 8 depicts several mesh faces 800 and the generation of edge clips 802 at edge intersections. For example, FIG. 8 depicts at (a) contact point 804 and edge clip 802 for a hull edge 806 intersecting with a concave edge 808 of the mesh face 800. FIG. 8 also depicts at (b) a scenario where the hull face 810 intersects with concave edge 812 of mesh face 800 as well as contact points 814 and edge clip 802. FIG. 8 also depicts at (c) a scenario for generating edge clip 816 for a situation where a convex hull edge 818 is outside the bounds of mesh face 820 and closest to the concave edge 822. The scenario depicted at (d) in FIG. 8 is for when the hull edge 818 is outside the bounds of the mesh face 820 and closest to a vertex connected to two concave edges 822 of the mesh faces 820 where two edge clips 816 are generated, one for each edge 822. It should be noted that the edges 808, 812, and 822 shown in FIG. 8 as concave can be concave or flat.

FIG. 9 depicts a top view of a convex hull face 900 colliding with a mesh edge 902, according to some embodiments. As shown in example (a) in FIG. 9, the mesh edge 902 includes a mesh vertex that is connected to concave edge 904. Using the face walking algorithm, edge clip 906 is created at the vertex. Example (a) in FIG. 9 also includes contact point 908 for the mesh edge 902 intersecting within the bounds of the hull face 900. In example (b) in FIG. 9, edge clip 906 is created at the closest mesh vertex of mesh face 910 when the hull face is 900 is outside the bounds of the mesh face 910 and connected to a flat or concave edge (e.g., edge 904).

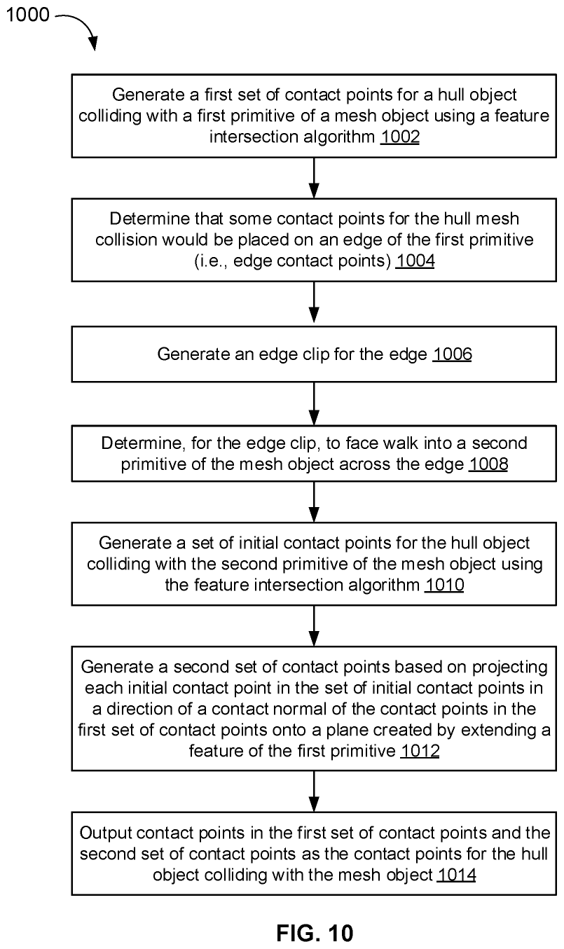

FIG. 10 is a flow diagram of method steps for determining contact points for collision between a convex hull and a mesh, according to an embodiment. In various implementations, the method can be performed by the processor 110, the graphics processor 116, or a combination of the processor 110 and the graphics processor 116.

The method begins at step 1002, where a processor generates a first set of contact points for a hull object colliding with a first primitive of a mesh object using a feature intersection algorithm. A contact point normal for the contact points in the first set of contact points is a direction along which the contact points on two objects (e.g., the hull object and the mesh object) are constrained by in order to resolve collisions between the two objects.

At step 1004, the processor determines that some contact points for the hull mesh collision would be placed on an edge of the first primitive (i.e., edge contact points). The edge may be a concave edge or a flat edge of the mesh object.

At step 1006, the processor generates an edge clip for the edge.

At step 1008, the processor determines, for the edge clip, to face walk into a second primitive of the mesh object across the edge.

At step 1010, the processor generates a set of initial contact points for the hull object colliding with the second primitive of the mesh object using the feature intersection algorithm.

At step 1012, the processor generates a second set of contact points based on projecting each initial contact point in the set of initial contact points in a direction of the contact point normal for the contact points in the first set of contact points onto a plane created by extending the feature of the first primitive.

At step 1014, the processor outputs contact points in the first set of contact points and the second set of contact points as the contact points for the hull object colliding with the mesh object.

An edge clip may be generated in response to determining the edge or the face of the hull object intersects with the flat edge or the concave edge of the second primitive of the mesh object. In some embodiments, a face walk may be performed into a third primitive of the mesh object based at least in part on the presence of another primitive on the other side of the flat edge or the concave edge of the mesh object. Although the above description includes a third primitive, the embodiments disclosed herein are not limited to performing a face walk only between three primitives and that instead the disclosed embodiments describe features for face walking into as many primitives are needed or required. In an embodiment, a determination may be made that an end of the third primitive has been reached, and that the second primitive has been processed in response to extracting features from the edge clip between the second primitive and the third primitive. The method may cease to face walk toward the second primitive in response to the second primitive having already been processed.

In an embodiment, a feature from the second primitive may be extracted and a second set of contact points for the hull object intersecting with the second primitive of the mesh object may be generated using a feature intersection algorithm and the feature. The edge clip may be generated further in response to determining that the edge, the face, or vertex of the hull object is within a region, such as a Voronoi region, of the concave edge of the mesh object. The edge clip may further be generated in response to determining that the edge, the face, or the vertex of the hull object is within the region of the concave edge of the mesh object and outside the bounds of a face of the mesh object.

In one embodiment, primitive vertices of the mesh object may be obtained in response to determining that a face of the mesh object is a promoted feature. Determining to face walk into the second primitive of the mesh object for the edge clip may be determined based at least in part on determining a presence of a valid primitive pair colliding with the hull object in the second primitive of the mesh object. In some embodiments, determining to face walk into the second primitive of the mesh object for the edge clip may be determined based at least in part on determining that the second primitive of the mesh object has not previously been visited and/or based on a determination that the face walking into the second primitive forms an angle less than 90° with respect to the first primitive. In some embodiments, the edge clip may be stored in a data structure that include an identifier for the mesh object intersected by the hull object.

A primary feature, as used herein, includes the feature (vertex, edge, or face) of a primitive that is most perpendicular of the best separating direction (BSD) between the primitive of the mesh and the hull object. In the case of a tie, some embodiments choose the higher order feature. For example, the order of preference for the system may be first face, then edge, then vertex. A promoted feature, as used herein, includes a higher order feature that is considered close enough to perpendicular to the best separating direction (BSD) (for example, within a threshold) such that it would be beneficial to use it to generate contacts. In the case of a tie, the system may choose the higher order feature.

In one implementation, the following notation may be used to identify a primary feature and promoted feature: {Primary Feature, Promoted Feature}. The following pseudo algorithm may be used to update a feature determination algorithm using the deferred and pass-through feature types:
If an edge is the best feature, and the edge is flat or concave, set the features for the primitive as {Edge, Deferred}
If a vertex is the best feature, and both adjacent edges are flat, set the features for the primitive as {Vertex, Pass-through}
If the vertex is the best feature and at least one adjacent edge is flat or concave, set the features for the primitive as {Vertex, Deferred}

In some scenarios, mesh regions around concave and flat edges have a point of closest approach and best separating direction for associated mesh primitives, which can be back-facing. For collision between convex hulls, a system would reject back-facing features and does so because convex hulls are closed and treated as a single object resulting in a better non-back-facing feature that can be used instead. However, for meshes that are processed as a single primitive at a time, collision between a convex hull and mesh primitive can appear to be back-facing the mesh primitive. The present system creates front-facing contacts only. This is done in order to prevent competing contact directions as well as unnecessary contacts being generated. For example, if a table is modelled as a mesh using many cells, it would be detrimental to produce contacts with opposite normal directions as it will be impossible to satisfy all contact constraints, and contacts with the back-facing bottom surface of the table are not required to prevent penetration with the top surface. In one embodiment, the system may consider all edges/faces as potential features when determining a best face and edge. Since all meshes are treated as a single primitive at a time for the initial feature determination step, the face and the two edges connected to a maximum vertex (the vertex in the mesh face furthest along the BSD) are considered as potential features—even if they are back facing. The potential features are stored whether the face is back facing or not. When the system determines if the face is the best feature, it also checks an angle between the face normal and best separating direction and whether it is back-facing. However, the system does not accept the face as the best feature if it is back-facing. If an edge is the best feature, the edge would normally be rejected if it is connected to a back-facing face. Edge features are also normally rejected based on the angle between the BSD and the bisecting vector between the two faces connected to the edge. This is referred to as edge cosine rejected and is performed in order to prevent duplicate contacts being generated by each mesh primitive connected to the edge, as well as preventing the creation of contacts that block valid motions. However, if the edge is flat or concave, it is marked by the system as Deferred for later processing. Similarly, if the vertex is the best feature, the vertex feature would normally be rejected by the edge cosine filtering if the face it's connected to is back facing with respect to the separating direction, or if either of the connected edges are edge cosine rejected. However, the system marks vertices connected to flat or concave edges as either Deferred or Pass-through for later processing. For back-facing or edge cosine rejected cases when there are no concave or flat edges as or connected to the best feature, the system normally rejects the primitive for contact generation.

In an embodiment, the system, after an initial pass of feature determination, will have a collection of primitive pairs whose features are either resolved (e.g., Face, Edge, Vertex or Reject) or unresolved (e.g. Deferred). Primitives with unresolved features are resolved in a second pass in order to determine the correct feature to use when generating contacts or to reject contacts with the primitive. It should be noted that the system considers Pass-through features as semi-resolved since it does not directly generate contacts for primitives with this feature type or try to resolve this feature type. The Pass-through primitives may be used when processing unresolved primitives or during face walking in order to not reject features. When resolving features, the system determines what the correct feature is, but also considers what the feature normal should be.

In some embodiments, the system also takes into account whether it needs to do a feature promotion. Generally, the best separating direction is not useful for determining a good contact normal in deferred cases, since the path of the hull against a single mesh primitive, as seen by a time of impact Gilbert-Johnson-Keerthi (GJK) distance algorithm (i.e., which provides a method of determining the minimum distance between two convex sets) can penetrate other primitives of the mesh that are not currently being considered and be back-facing the primitive being considered. As used in the present disclosure, a source primitive includes a primitive (for example, mesh face) with primary and promoted features that are resolved. The system of the present disclosure uses information about source primitives to determine what features unresolved primitives should use. A target primitive includes a primitive whose promoted feature is unresolved. The system attempts to use a source primitive to determine what features should be used on the target primitive.

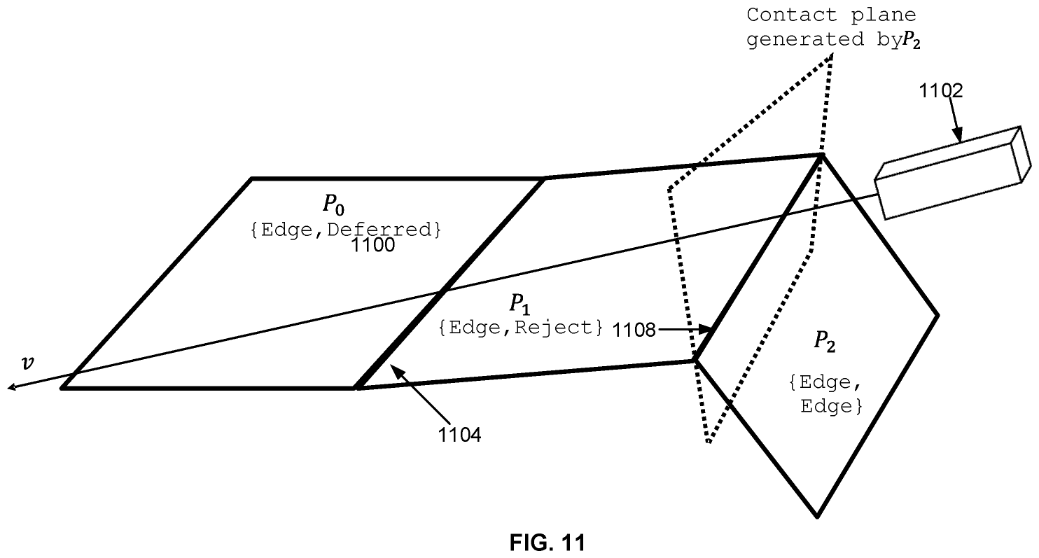

FIG. 11 is a conceptual diagram illustrating a hull object potentially colliding with a mesh object and determining to reject a target primitive when a corresponding source primitive is rejected, according to an embodiment. Hull object 1102 is travelling in the direction of vector v. In some embodiments, if a source primitive has a Reject feature or tag then the system resolves a corresponding target primitive as Reject. An example of why this is executed is depicted in FIG. 11. In FIG. 11, primitive P₀ is the target primitive with features determined as {Edge, Deferred}. The promoted feature of the target primitive 1100 is Deferred as the point of closest approach by the hull object 1102 is on a concave edge 1104. Primitive P₁ is the source primitive (e.g., resolved primitive) with features determined as {Edge, Reject}. The promoted feature for the source primitive P₁ is Reject, as the point of closest approach is on the convex edge 1108 and the edge is cosine rejected.

In FIG. 11, primitive P₂ is a resolved primitive with features determined as {Edge, Edge}. The point of closest approach by the hull object 1102 to primitive P₂ is the convex edge 1108. Using the scenario depicted in FIG. 11, a system of the present disclosure would not need to generate contact points with the target primitive P₀ as the system has already determined that contacts with source primitive P₁ are not needed, since resolved primitive P₂ blocks motion of the convex hull object 1102 across the front of source primitive P₁. In scenarios where the promoted feature of source primitive P₁ is designated as Vertex, the system would also reject all unresolved primitives, such as primitive P₀ in the chain for similar reasons. If the system were to generate face contact points with target primitive P₀, then an infinite contact plane would cut through the face of primitive P₂, which could incorrectly constrain the motion of the convex hull object 1102. As such, FIG. 11 depicts a scenario of resolving a chain of primitives where the target primitive P₀ is rejected because the source primitive P₁ is also rejected. This results in the system only needing to resolve against source primitives that are determined to be Face or Edge.

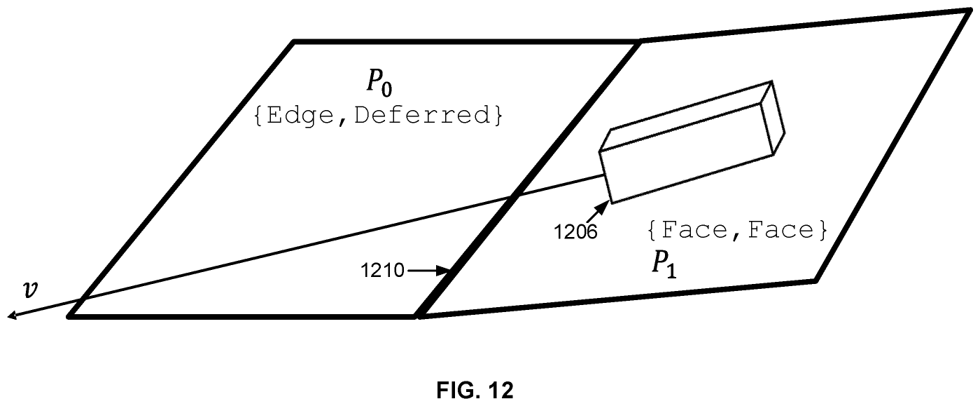

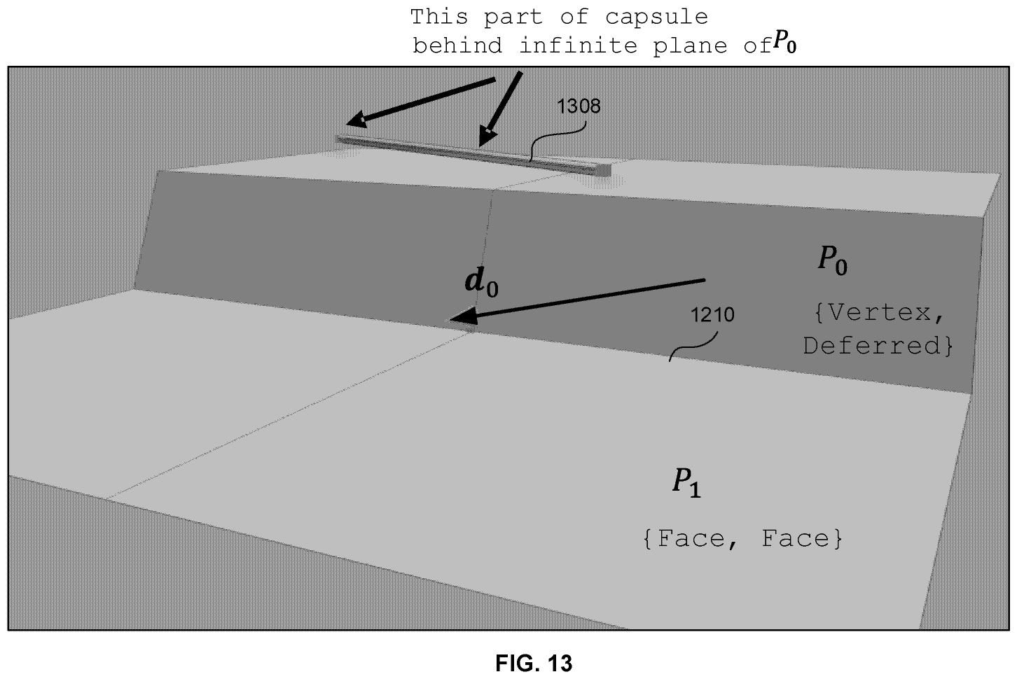

FIGS. 12-13 are conceptual diagrams illustrating a hull object colliding with a mesh object and resolving a target feature where the source primitive primary feature is a face, according to an embodiment. FIGS. 12-13 depict a scenario where the source primitive P₁ has determined features of {Face, Face}.

Hull object 1206 is travelling in the direction of vector v. The system of the present disclosure may attempt to set the target primitive P₀ as {Face, Face}. However, the system must still be sure that adding face contacts do not cause any problem contacts to be generated. An example of this is depicted in FIG. 13. The best separating direction of target primitive P₀ is shown as do in FIG. 13. The capsule 1308 extends behind an infinite plane of the face of target primitive P₀.

In this scenario, if the system attempts to generate contact points for the hull object 1308 with a face of target primitive P₀, an implemented feature intersection algorithm will incorrectly determine that the end of the capsule 1308 is penetrating and therefore push the capsule 1308 forward. To avoid this scenario of pushing the capsule 1308 forward, the system requires that the best separating direction from GJK is close (for example, within a threshold φ) to being perpendicular to the concave edge 1210. In some embodiments, the angle (θ) between the edge direction and separating direction should be:

$$\frac{π}{2} - ϕ \leq θ \leq \frac{π}{2} + ϕ .$$

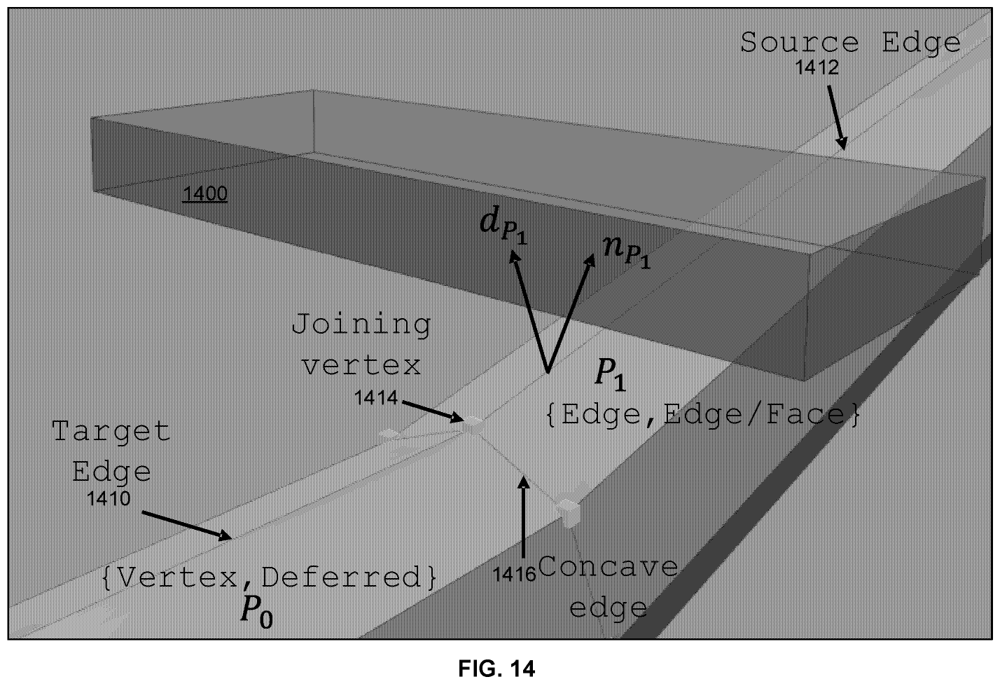

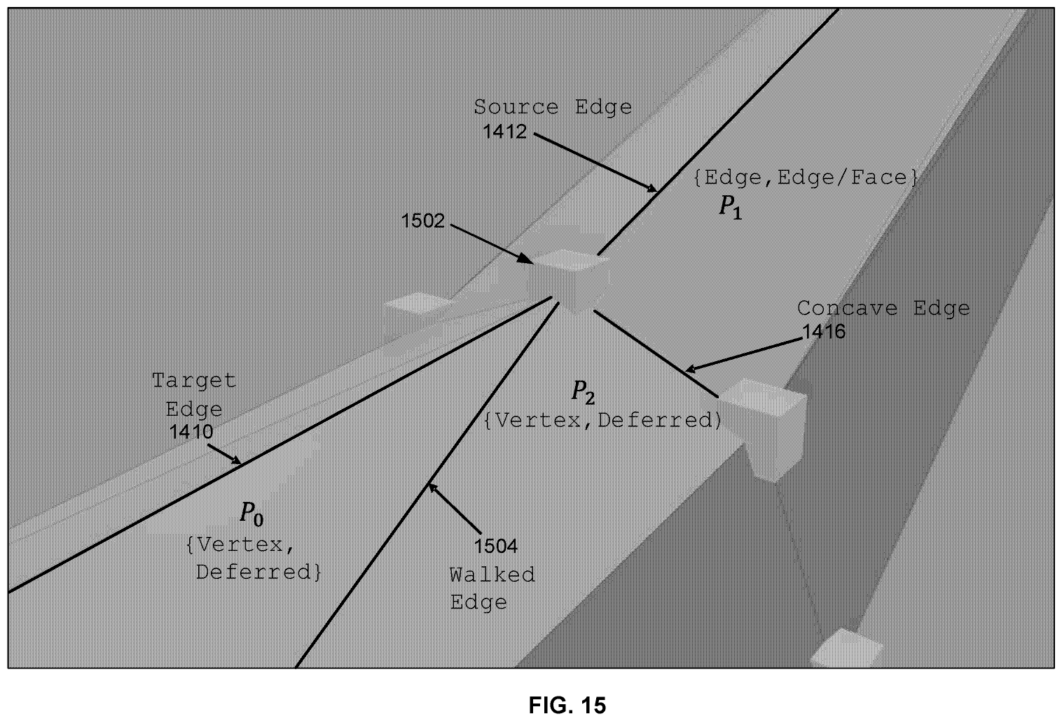

FIG. 14 is a conceptual diagram illustrating a hull object 1400 colliding with a mesh object and resolving a feature where a primary feature of a source primitive is a convex edge, according to an embodiment. FIG. 14 depicts a scenario where the system has identified primitive P₁ as the source primitive. The primary feature of source primitive P₁ is the convex edge 1412 (source edge) and the promoted feature may be either the convex edge 1412 or the face. The best separating direction (d_{P1}) and face normal (n_{P1}) for source primitive P₁ are also depicted in FIG. 14. The primitive P₀ is the target primitive and the feature during a first pass was designated as {Vertex, Deferred}. The system implementing the features described herein may attempt to set the primary feature of target primitive P₀ to the target edge 1410, which is the edge connected to the primary feature edge (e.g. source edge 1412) of the source primitive P₁ through joining vertex 1414. The system may obtain the target edge 1410 by finding the edge connected to the joining vertex 1414 and the edge connecting the neighboring primitive (e.g. the concave edge 1416). It should be noted that in general the source edge 1412 and the target edge 1410 may not be on neighboring primitives that share common edges in some examples. An example of this scenario is depicted in FIG. 15.

In FIG. 15, a third primitive P₂ is inserted between source primitive P₁ and target primitive P₀ by triangulating P₀ by inserting a flat edge. In the scenario depicted in FIG. 15, the third primitive P₂ does not change how the system generates contact points and is capable of resolving any number of insertions that result in a number of triangulations involving flat edges to get the same result. In one situation, the third primitive P₂ uses the Pass-through feature to allow contacts generated with target primitive P₀ to be extended to third primitive P₂ (via face walking), but does not generate contacts with third primitive P₂ itself.

However, the scenario depicted in FIG. 15 results in the system selecting source primitive P₁ and target primitive P₀. The source edge 1412 and the target edge 1410 of FIG. 15 are no longer on neighboring primitives that share an edge, but they do share a vertex 1502. The system is able to still identify the set of edges that need to be walked to go from the source primitive P₁ to the target primitive P₀. The walked edge 1504 of FIG. 15 depicts a path to get from the target edge 1410 of target primitive P₀, to the concave edge 1416 and finally to the source primitive P₁ containing source edge 1412. In order to accomplish this, the system first checks that the source edge 1412 and the target edge 1410 are connected, and if they are not connected, the system rejects the primitive. The system implementing the feature determination process described herein may also resolve scenarios where the target edge is not convex, which can typically happen when there are extra faces for a mesh object (for example if the target primitive being considered were P₂). Such possible scenarios for this include ones where both edges are concave, in which case the feature is set as a Face, or one edge is flat and one edge is flat or concave, in which case the feature is set as Pass-through.

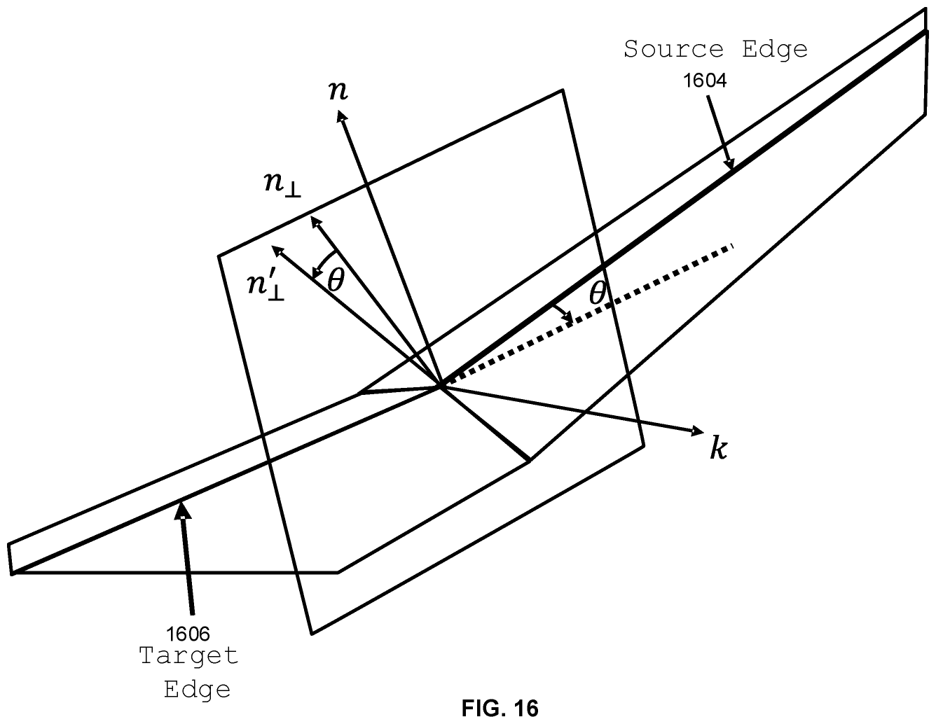

FIG. 16 is a conceptual diagram illustrating decomposition of the source primary feature normal into two vectors, according to an embodiment. In some embodiments, the system implementing the feature determination process constructs a primary normal and a promoted normal for a target primitive. Generally, the best separating direction from GJK is a poor choice, since the convex hull can be traveling through the mesh. In a continuous limit scenario, the convex hull would slide smoothly over the join between the two edges. The system attempts to mimic this behavior by constructing a normal that one would expect for this transition to give an equivalent normal on the target primitive. The system can then use this normal to determine if it needs to promote the feature or not. In order to accomplish this, the system computes the angle (Θ) and axis (k) that would rotate the source edge on to the target edge. The system then decomposes the source primary feature normal (n) into two vectors that are parallel and perpendicular (n_{⊥}) to axis (k). FIG. 16 depicts the system computing the angle between the source edge 1604 and target edge 1606 as (Θ). FIG. 16 depicts the system rotating the part of the feature normal (n) that is perpendicular to axis (k) by the angle (Θ) and thus rotates (n_{⊥}) onto (n_{⊥}′). The system keeps the component of the normal (n) that is parallel to axis (k).

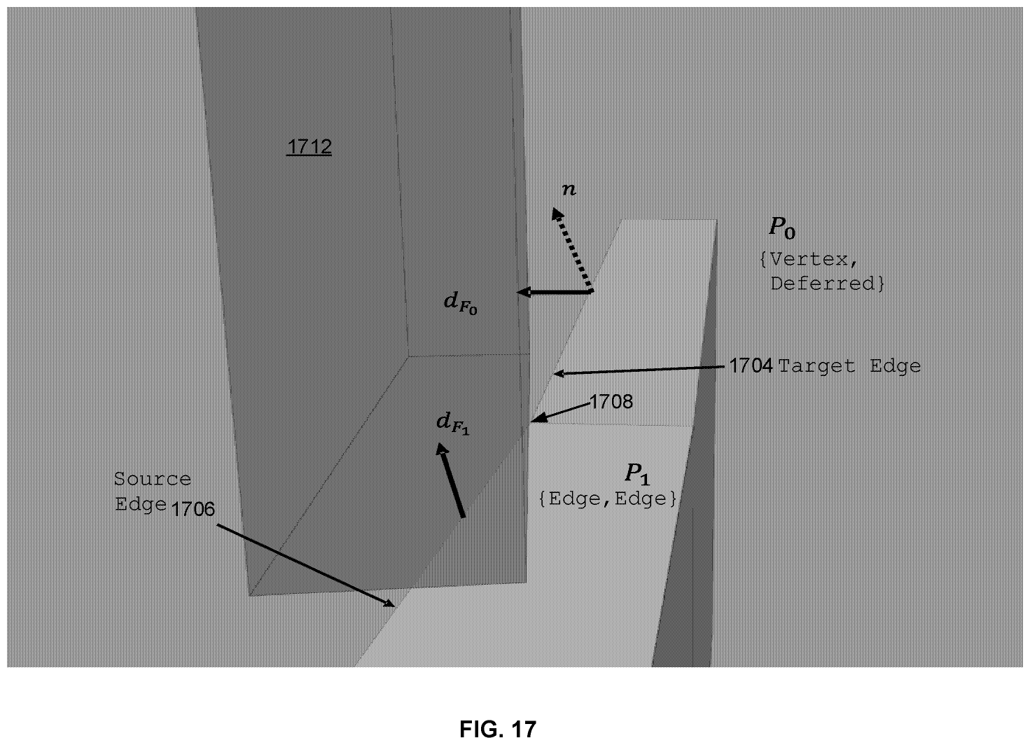

FIG. 17 is a conceptual diagram depicting the generation of incorrect contacts between a hull 1712 and mesh object, according to an embodiment. In order to rotate the source edge onto the target edge correctly, as depicted above in FIG. 16, the system needs to ensure that the best separating direction from GJK for the target primitive is consistent with generating edge contacts with the target edge 1704. FIG. 17 depicts an example of how this can go wrong. In FIG. 17, the primitive P₁ is the source face and has the features {Edge, Edge}. The target primitive P₀ has features {Vertex, Deferred} and the target edge 1704 is connected to the source edge 1706. The best separating direction of the target primitive P₀ is shown as d_{F0}, and the best separating direction of the source primitive P₁ is shown as d_{F1}. However, the best separating direction of the target primitive P₀ (d_{F0}) is vastly different from the primary normal of the source edge 1706. This is because the hull 1712 is angled so it is dipping below the convex edge, and in this case the best feature is the vertex 1708 (i.e., the hull 1712 is almost touching the vertex 1708). Following the process described above with reference to FIG. 16, the system rotates the source primary feature normal resulting with a normal (n) as indicated by the dotted line. However, this would generate contacts on the bottom face of the hull 1712, which is below the contact plane resulting in the hull 1712 being incorrectly pushed upwards.

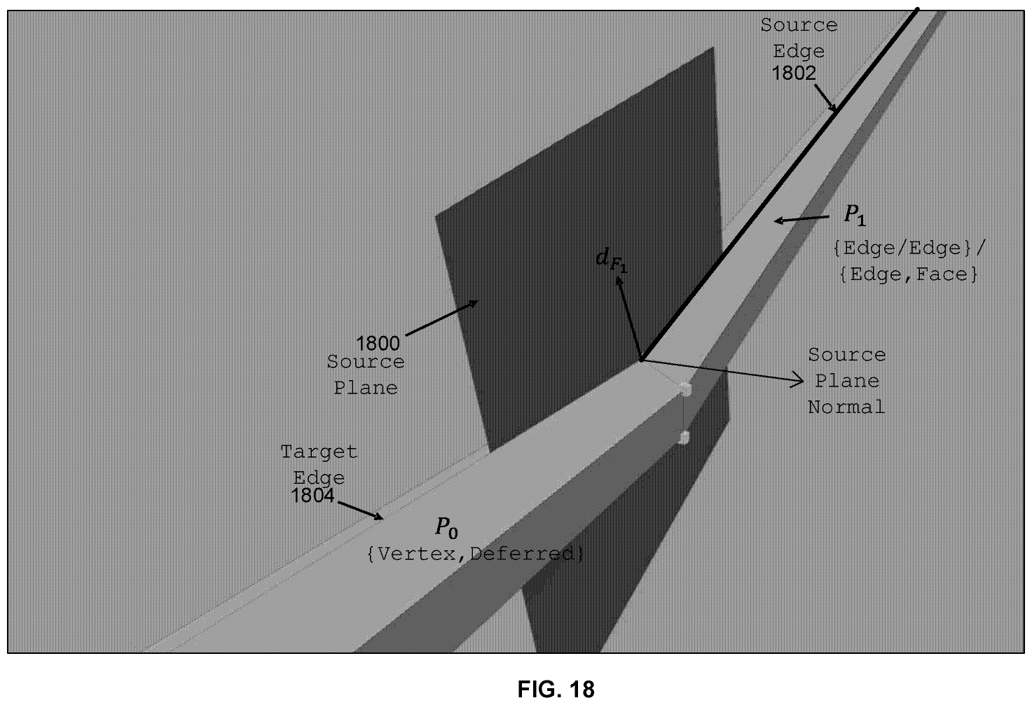

FIG. 18 is a conceptual diagram illustrating generation of a source plane when a primary feature of a source primitive is a convex edge, according to an embodiment. To resolve the scenario depicted and described above with reference to FIG. 17, the system may construct a source plane 1800. The source plane 1800 is the plane with normal perpendicular to the source edge 1802 and primary feature normal (dF₁). In order to prevent spurious contact directions, the system requires that: the best separating direction (as computed by GJK) of the target face (d_{F0}) to be close to this plane 1800; the target edge 1804 is close to being in the source plane 1800; and the system uses threshold angle to define “close.” If the best separating direction of the target primitive P₀ is outside the source plane 1800, and the best feature on the target primitive P₀ (from GJK) is the vertex, then the system may promote the vertex feature to an edge by determining that the best separating direction is within the edge promotion angle. After the system determines the equivalent primary feature normal, it can check if it can promote the edge to the face and then check that the edge is not edge cosine rejected.

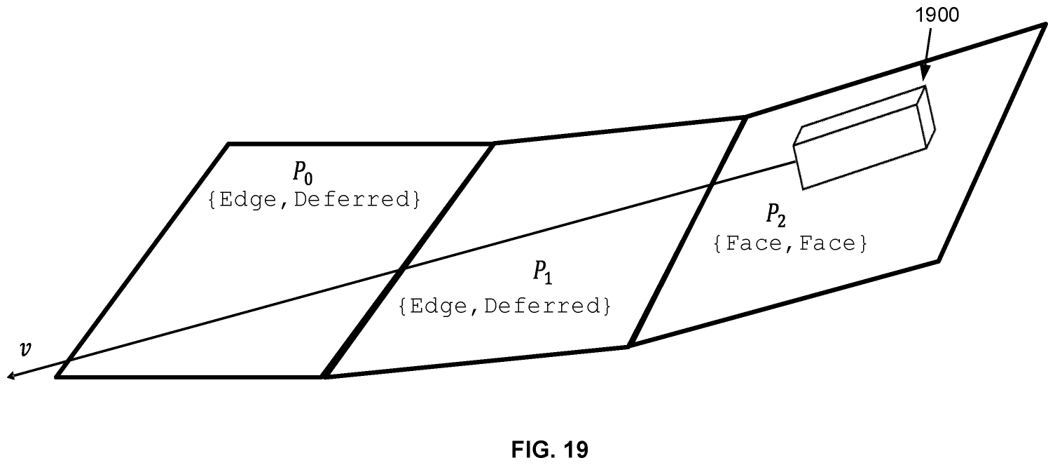

FIG. 19 is a conceptual diagram depicting an example of an unresolved feature chain, according to an embodiment. Hull object 1900 is travelling in the direction of vector v. Described herein is how the system determines the source and target primitives that are used to resolve deferred features. A common scenario is depicted in FIG. 19, where the convex hull 1900 is initially above primitive P₂, and during a time step moves across primitive P₁ and primitive P₀. The primary and promoted features for primitive P₂ are {Face, Face}, and for both primitive P₁ and primitive P₀ are {Edge, Deferred}. In this scenario, depicted in FIG. 19 there are two unresolved primitives (P₁ and P₀) and one resolved primitive (P₂). The system of the present disclosure takes the primitives that are unresolved (P₁ and P₀) and resolves them based on the resolved primitive P₂. As described herein, the system resolves the chain that needs to resolve primitive P₀ by first resolving primitive P₁ by looking at the features used in primitive P₂.

One solution to resolve this is to designate primitive P₂ as the source primitive and primitive P₁ as the target primitive, and resolve as described above. After resolving primitive P₁, use it as the source primitive and use primitive P₀ as the target primitive to resolve, as described above. However, in more general cases, the system builds a chain of primitives that can be processed in order to resolve all remaining unresolved primitive pairs. The properties of this chain should be:
one end of the chain has a resolved primitive (e.g., source primitive);
each subsequent link in the chain is a walk over a single edge into a primitive with either an unresolved or semi-resolved feature (this feature can be either an unresolved edge or an unresolved vertex);
the chain ends on a target primitive that is capable of being resolved; and
there is a single path from the target primitive to the source primitive.

Once a chain is built, the system can walk over the chain resolving primitives as it goes. It should be noted that the target primitive is not necessarily the end of the chain. In the example described above, both primitive P₀ and primitive P₁ are valid targets. The system can resolve each primitive using two chains where each is a target (i.e., one chain of primitive P₁ to primitive P₂, and one chain of primitive P₀ to primitive P₁), thereby not requiring a full chain.

The system builds chains starting from the target primitive end because:
source primitives could have many potential paths to target primitives (e.g., a face with two concave edges could have many potential routes to independent target primitives, or the best edge is not necessarily connected to a route to the target primitives); and
by selecting good initial resolvable target primitives, the system can prevent having to build out the chain in both directions—towards the source and a resolvable target.

It should be noted that the source and target primitives may not be in the neighboring primitive and that the chain of unresolved primitives could be much longer. Thus, the system ensures it starts on a target primitive where it knows it only needs to walk in one direction towards the source primitive. The unresolved primitives may be ordered according to the following way for processing:
1. {vertex, deferred} where the vertex is connected to a convex edge and flat edge;
2. {vertex, deferred} where the vertex is connected to a convex edge and concave edge;
3. {edge, deferred};
4. remaining {vertex, deferred} pairs (both edges connected to the vertex are either flat or concave).

The system orders vertices with convex edges first, as it will never walk through a convex edge (which are treated as terminating points), and thus choosing vertices with one as a convex edge limits the system from having to walk in both directions.

Similarly, the system orders vertex pairs where both edges are flat or concave last, as this is the worst case where it would have to walk both directions. The edges are placed in the middle as they are often resolved by walking across the concave edge, except for some scenarios. By processing edges after vertices with convex edges, the system can resolve the corner cases. At each link in the chain, the system stores the index of the primitive and the edges in the mesh it will walk across next. For vertex walks, the aim is to try to walk around the faces connected to the vertex by crossing connected edges, whilst the unresolved feature is connected to the vertex. For edge walks, the system walks across the best edge feature, which will always be the concave edge. A main algorithm for the above-described steps contains a sub-algorithm for extracting the neighboring primitive feature and deciding if the system is finished building the chain, and if the system is finished, what the resolution is (i.e., does the system reject the chain or not). The sub-algorithm in pseudocode is:

### Extract Neighbor Features:

Flag the neighboring primitive as processed so that the system doesn't end up doing a circular walk.
Reject the chain if the system has performed a circular walk.
Reject the chain if there is no neighboring primitive, the neighboring primitive doesn't collide, or it's rejected.
Stop the chain if the system has found a resolved primitive—this is the source primitive.

The main algorithm for building the chains in pseudocode includes:
Check if the unresolved feature is an edge or vertex;
   If an edge, add to the chain using the concave edge as the next edge to walk, extract the neighboring primitive features to determine to continue building the chain, if continue to build go back to the top of the main algorithm;
   If vertex
      Determine what the next edge to walk is;
      Check if this is the first link in the chain, if it isn't the first link then
         Get the edge walked across to get this primitive, if this edge is connected to the unresolved vertex get the other connected edge and attempt to walk that;
         If the edge to walk is convex then reject the chain since the system has failed to find a source primitive;
      If it is the first link or the previous link isn't connected to the unresolved vertex
         Find the convex edge (there is at most one by construction), mark the other edge as the one the system is walking through
         Both edges are flat or both edges are concave—the system picks the edge most perpendicular to the BSD to walk;
         One edge is flat and one edge is concave—pick the concave edge;
      Add to the chain {PrimitiveIndex, EdgeToWalkIndex};
      Extract the neighboring primitives feature to determine to continue to build the chain—if not the system stops here;
      Continue to build the chain around the current vertex by determining the next edge to walk, adding to the chain and extracting the next primitives feature;
         If at any point the chain is complete (resolved or rejected)—stop;
         If the neighbor primary feature is a different vertex, stop and return to the top of the algorithm;
         If the neighbor primary feature is an edge and the edge is not connected to the vertex return to the top of the algorithm;
         If the next edge to walk is a convex—stop;
      If the initial and final edges in a vertex walk are convex it is possible the vertex is the best feature—to check this the system determines if the best separating directions of each primitive in the chain agree, if so the system accepts the vertex.

It should be noted that in the vertex use cases in the algorithm above when both edges are either flat or concave, and this is the first link in the chain, the system may have to walk both edges to find an appropriate target primitive if the source primitive is an edge.

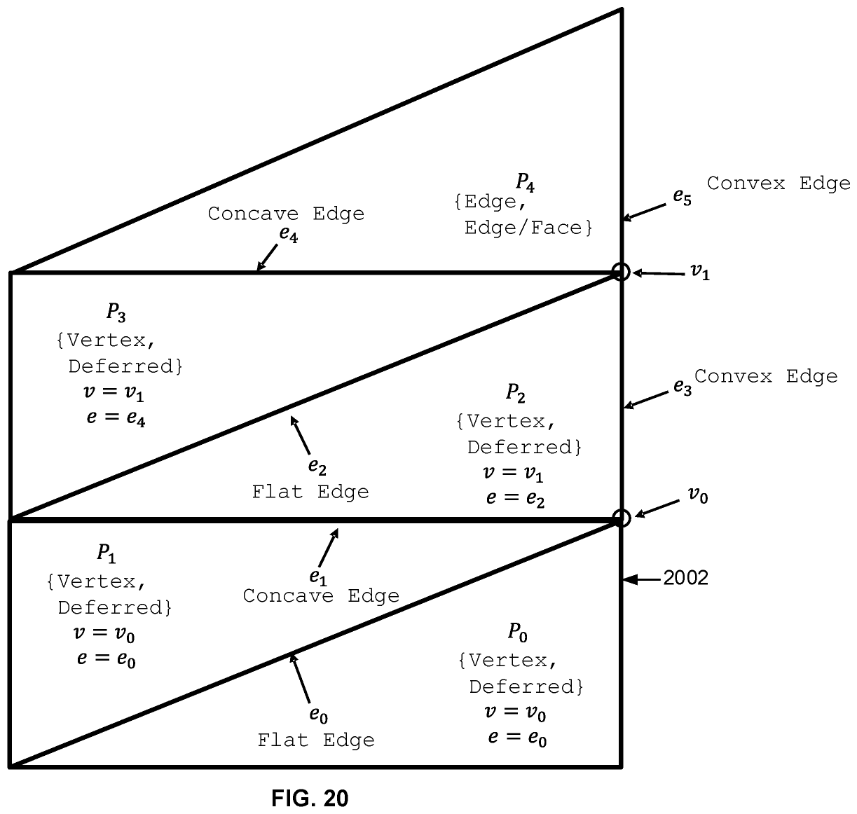

FIG. 20 is a conceptual diagram depicting generating of a chain of primitives to resolve remaining unresolved primitive pairs for mesh objects, according to an embodiment. In the example depicted in FIG. 20, the system of the present disclosure would sort primitive P₀ into first position since the vertex feature v₀ is connected to a convex edge 2002 and flat edge e₀ (this is the target primitive). The system would determine that the feature is vertex v₀ and that since one edge is convex (edge 2002) and one is flat (edge e₀), it would pick the flat edge e₀ to walk. The system would then add {P₀, e₀} to the chain. In some embodiments, the system would then extract features for primitive P₁. As primitive P₁ is not resolved or rejected, the system determines to continue to build the chain. The best feature at this next step is vertex v₀, which is the same as for the previous primitive. As the system previously walked over flat edge e₀, the next edge connected to vertex v₀ is concave edge e₁. The system would then add {P₁, e₁} to the chain.

The system would continue by extracting features for primitive P₂. The system would determine that the primitive P₂ is not resolved or rejected and so it would continue to build the chain. The best feature for primitive P₂ is vertex v₁, which is not the previous vertex, thus the system determines to stop walking vertex v₀ and return to the top of the main algorithm. As vertex v₁ is connected to convex edge e₃ and flat edge e₂, it picks the flat edge e₂ to walk. The system then adds {P₂, e₂} to the chain. The system continues by extracting features for primitive P₃ and determines that the primitive P₃ is not resolved or rejected—thus it determines to continue to build the chain. The best feature is still vertex v₁, which is the same as for the previous primitive P₂. Since the system has already walked e₂ to get to its current position, concave edge e₄ is the next edge to walk. The system then adds {P₃, e₄} to the chain. Finally, the system extracts features for primitive P₄. As primitive P₄ is resolved already, primitive P₄ is identified to be the source primitive and the system stops building the chain. As the system has generated a chain from the target primitive P₀ to the source primitive P₄, it can resolve the features for each primitive in the chain. If the chain was rejected, the system now goes through each primitive in the chain and rejects it. Otherwise, the system starts at the source primitive P₄ and walks backwards along the chain resolving source-target pairs, as described above. When the system resolves a primitive, that primitive becomes the new source primitive for the remainder of the chain. The system may reject primitives mid-way through the chain and when this happens all subsequent primitives are rejected.

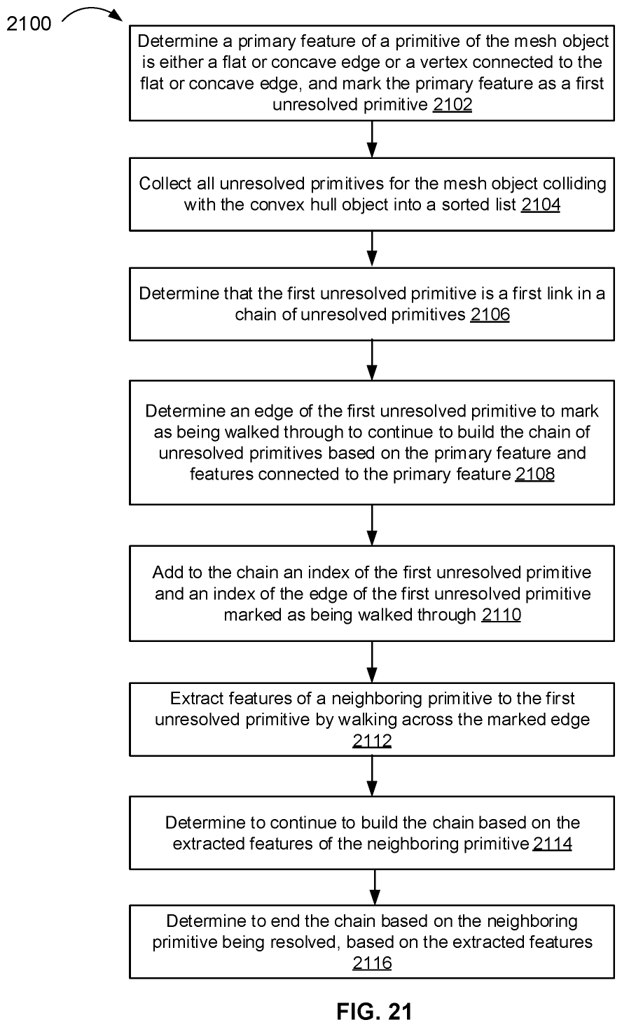

FIG. 21 is a flow diagram of method steps for feature determination for a convex hull colliding with a mesh object, according to an embodiment. In various implementations, the method can be performed by the processor 110, the graphics processor 116, or a combination of the processor 110 and the graphics processor 116.

The method begins at step 2102, where a processor determines a primary feature of a primitive of the mesh object is either a flat or concave edge or a vertex connected to the flat or concave edge, and marks the primary feature as a first unresolved primitive.

At step 2104, the processor collects all unresolved primitives for the mesh object colliding with the convex hull object into a sorted list.

At step 2106, the processor determines that the first unresolved primitive is a first link in a chain of unresolved primitives.

At step 2108, the processor determines an edge of the first unresolved primitive to mark as being walked through to continue to build the chain of unresolved primitives based on the primary feature and features connected to the primary feature.

At step 2110, the processor adds to the chain an index of the first unresolved primitive and an index of the edge of the first unresolved primitive marked as being walked through.

At step 2112, the processor extracts features of a neighboring primitive to the first unresolved primitive by walking across the marked edge.

At step 2114, the processor determines to continue to build the chain based on the extracted features of the neighboring primitive.

At step 2116, the processor determines to end the chain based on the neighboring primitive being resolved, based on the extracted features.

In one embodiment, the extracted features of the neighboring primitive include that the neighboring primitive has been flagged as processed in the chain or is indicated as a resolved primitive. In embodiments, the processor rejects the chain based on the extracted features of the neighboring primitive indicating that no neighboring primitive exists, that the neighboring primitive doesn't collide with the convex hull, the neighboring primitive has already been marked as rejected, or based on a determination that a circular walk has been completed based on an index of the neighboring primitive and the index of the edge marked as being walked through. In some variations, the primary feature of an unresolved primitive is a concave edge. The system implementing the feature determination features described herein adds to the chain an index of the edge, and extracts features of the neighboring primitive to the unresolved primitive by walking across the concave edge of the first unresolved primitive.

In some instances, a chain can be built for unresolved primitives where a common vertex is the primary feature, or the common vertex is connected to the edge that is the primary feature. The chain starts at either an unresolved primitive where one edge is convex, or by walking into the primitive through a flat or concave edge from another unresolved primitive. Further unresolved primitives are added to the chain by walking through the edge connected to the vertex that is not the starting edge of the primitive (i.e. the convex edge or the edge already walked through to get to this primitive). In embodiments, the processor determines that the unresolved feature of the first unresolved primitive of the list of unresolved primitives is the vertex; determines which of the two edges connected to the vertex to walk through; adds to the chain an index of the edge; and extracts features of the neighboring primitive to the first unresolved primitive by walking across a the edge of the first unresolved primitive

In one embodiment, determining the edge of the first unresolved primitive to mark as being walked through to continue to build the chain of unresolved primitives is further based on both edges of the first unresolved primitive being flat or concave. In embodiments, the edge of the first unresolved primitive to mark as being walked through is a concave edge based on the first unresolved primitive having one flat edge and one concave edge. In some instances, the edge of the unresolved primitive to walk through is the edge most perpendicular to the best separating direction if both connected edges are flat or both connected edges are concave.

In some examples, determining to stop building the chain around the common vertex may be based on the extracted features of the neighboring primitive where the primary feature is a different vertex to the common vertex, or the primary feature is an edge not connected to the common vertex. In an embodiment, determining to continue to build the chain is based on the primary feature of the unresolved primitive.

In some examples, determining to stop building around the common vertex chain may be based on the extracted features of the neighboring primitive where the next edge to walk is a convex edge. In some instances, the system may reject the chain in response to determining that the next edge to walk of the unresolved primitive is a convex edge.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

It should be understood that the original applicant herein determines which technologies to use and/or productize based on their usefulness and relevance in a constantly evolving field, and what is best for it and its players and users. Accordingly, it may be the case that the systems and methods described herein have not yet been and/or will not later be used and/or productized by the original applicant. It should also be understood that implementation and use, if any, by the original applicant, of the systems and methods described herein are performed in accordance with its privacy policies. These policies are intended to respect and prioritize player privacy, and are believed to meet or exceed government and legal requirements of respective jurisdictions. To the extent that such an implementation or use of these systems and methods enables or requires processing of user personal information, such processing is performed (i) as outlined in the privacy policies; (ii) pursuant to a valid legal mechanism, including but not limited to providing adequate notice or where required, obtaining the consent of the respective user; and (iii) in accordance with the player or user's privacy settings or preferences. It should also be understood that the original applicant intends that the systems and methods described herein, if implemented or used by other entities, be in compliance with privacy policies and practices that are consistent with its objective to respect players and user privacy.

What is claimed is:

1. A method for feature determination for a convex hull colliding with a mesh object, the method comprising:
determining a primary feature of a primitive of the mesh object is either a flat or concave edge or a vertex connected to the flat or concave edge;
marking the primary feature as a first unresolved primitive;
collecting all unresolved primitives for the mesh object colliding with the convex hull object into a sorted list;
determining that the first unresolved primitive is a first link in a chain of unresolved primitives;
determining an edge of the first unresolved primitive to mark as being walked through to continue to build the chain of unresolved primitives based on the primary feature and features connected to the primary feature;
adding to the chain an index of the first unresolved primitive and an index of the edge of the first unresolved primitive marked as being walked through;
extracting features of a neighboring primitive to the first unresolved primitive by walking across the marked edge;
determining to continue to build the chain based on the extracted features of the neighboring primitive; and
determining to end the chain based on the neighboring primitive being resolved, based on the extracted features.

2. The method of claim 1, wherein the extracted features of the neighboring primitive include that the neighboring primitive has been flagged as processed in the chain or is indicated as a resolved primitive.

3. The method of claim 1, further comprising determining to discontinue to build the chain based on a determination that a circular walk has been completed based on an index of the neighboring primitive and the index of the edge marked as being walked through for the neighboring primitive derived from the extracted features of the neighboring primitive.

4. The method of claim 1, further comprising rejecting the chain based on the extracted features of the neighboring primitive indicating that no neighboring primitive exists, that the neighboring primitive does not collide with the first unresolved primitive, or the neighboring primitive has already been marked as rejected.

5. The method of claim 1,
wherein the primary feature for the primitive is a concave edge; or
wherein the primary feature for the primitive is a flat edge; or
wherein the primary feature for the primitive is a vertex with a corresponding convex edge and a flat edge; or
wherein the primary feature for the primitive is a vertex with a corresponding convex edge and a concave edge; or
wherein the primary feature for the primitive is a vertex where both edges of the vertex are either flat or concave.

6. The method of claim 1, further comprising:
determining a first edge to walk through of the first unresolved primitive based on the primary feature and the features connected to the primary feature;
adding to the chain an index of the first edge; and
extracting features of the neighboring primitive to the first edge by walking across the first edge.

7. The method of claim 1, further comprising rejecting the chain in response to determining that the edge of the first unresolved primitive to walk through to continue building the chain is a convex edge.

8. The method of claim 1, wherein determining the edge of the first unresolved primitive to mark as being walked through to continue to build the chain of unresolved primitives is further based on both edges of the first unresolved primitive being flat or concave.

9. The method of claim 1, wherein the edge of the first unresolved primitive to mark as being walked through is a concave edge based on the first unresolved primitive having one flat edge and one concave edge.

10. The method of claim 1, wherein determining to continue to build the chain is further based on the extracted features of the neighboring primitive indicating that a neighboring primary feature is at least one of a different vertex than the vertex of the first unresolved primitive, an edge that is not connected to the vertex of the first unresolved primitive, or that a next edge to walk is a convex edge for the neighboring primitive.

11. A non-transitory computer-readable storage medium storing instructions that, when executed by one or more processors, cause a computing device for feature determination for a convex hull colliding with a mesh object, by performing operations comprising:
determining a primary feature of a primitive of the mesh object is either a flat or concave edge or a vertex connected to the flat or concave edge;
marking the primary feature as a first unresolved primitive;
collecting all unresolved primitives for the mesh object colliding with the convex hull object into a sorted list;
determining that the first unresolved primitive is a first link in a chain of unresolved primitives;
determining an edge of the first unresolved primitive to mark as being walked through to continue to build the chain of unresolved primitives based on the primary feature and features connected to the primary feature;
adding to the chain an index of the first unresolved primitive and an index of the edge of the first unresolved primitive marked as being walked through;
extracting features of a neighboring primitive to the first unresolved primitive by walking across the marked edge;
determining to continue to build the chain based on the extracted features of the neighboring primitive; and
determining to end the chain based on the neighboring primitive being resolved, based on the extracted features.

12. The computer-readable storage medium of claim 11, wherein the extracted features of the neighboring primitive include that the neighboring primitive has been flagged as processed in the chain or is indicated as a resolved primitive.

13. The computer-readable storage medium of claim 11, further comprising determining to discontinue to build the chain based on a determination that a circular walk has been completed based on an index of the neighboring primitive and the index of the edge marked as being walked through for the neighboring primitive derived from the extracted features of the neighboring primitive.

14. The computer-readable storage medium of claim 11, further comprising rejecting the chain based on the extracted features of the neighboring primitive indicating that no neighboring primitive exists, that the neighboring primitive does not collide with the first unresolved primitive, or the neighboring primitive has already been marked as rejected.

15. The computer-readable storage medium of claim 11,
wherein the primary feature for the primitive is a concave edge; or
wherein the primary feature for the primitive is a flat edge; or
wherein the primary feature for the primitive is a vertex with a corresponding convex edge and a flat edge; or
wherein the primary feature for the primitive is a vertex with a corresponding convex edge and a concave edge; or
wherein the primary feature for the primitive is a vertex where both edges of the vertex are either flat or concave.

16. The computer-readable storage medium of claim 11, further comprising rejecting the chain in response to determining that the edge of the first unresolved primitive to walk through to continue building the chain is a convex edge.

17. The computer-readable storage medium of claim 11, wherein determining the edge of the first unresolved primitive to mark as being walked through to continue to build the chain of unresolved primitives is further based on both edges of the first unresolved primitive being flat or concave.

18. A device for feature determination for a convex hull colliding with a mesh, the device comprising:
a memory storing instructions; and
one or more processors configured to execute the instructions to cause the device to:
determine a primary feature of a primitive of the mesh object is either a flat or concave edge or a vertex connected to the flat or concave edge;
mark the primary feature as a first unresolved primitive;
collect all unresolved primitives for the mesh object colliding with the convex hull object into a sorted list;
determine that the first unresolved primitive is a first link in a chain of unresolved primitives;
determine an edge of the first unresolved primitive to mark as being walked through to continue to build the chain of unresolved primitives based on the primary feature and features connected to the primary feature;
add to the chain an index of the first unresolved primitive and an index of the edge of the first unresolved primitive marked as being walked through;
extract features of a neighboring primitive to the first unresolved primitive by walking across the marked edge;
determine to continue to build the chain based on the extracted features of the neighboring primitive; and
determine to end the chain based on the neighboring primitive being resolved, based on the extracted features.

19. The device of claim 18, wherein the extracted features of the neighboring primitive include that the neighboring primitive has been flagged as processed in the chain or is indicated as a resolved primitive.

20. The device of claim 18, wherein determining the edge of the first unresolved primitive to mark as being walked through to continue to build the chain of unresolved primitives is further based on both edges of the first unresolved primitive being flat or concave.
